(19) United States
(12) Patent Application Publication
(10) Pub. No.: US 2024/0346564 A1
(43) Pub. Date: Oct. 17, 2024

(54) SYSTEMS AND METHODS FOR IDENTIFYING A PAINT AND APPLICATOR COMBINATION

(71) Applicant: PPG Industries Ohio, Inc., Cleveland, OH (US)

(72) Inventors: Hong Li, Gibsonia, PA (US); Jacob M. Kupas, Pittsburgh, PA (US); Madeline M. Kash, Pittsburgh, PA (US); Wenjie Fei, Allison Park, PA (US); Minh A. Tong, Allison Park, PA (US)

(73) Assignee: PPG Industries Ohio, Inc., Cleveland, OH (US)

(21) Appl. No.: 18/293,905

(22) PCT Filed: Jul. 13, 2022
(86) PCT No.: PCT/US2022/073661

§ 371 Date: Jan. 31, 2024

Related U.S. Application Data
(60) Provisional application No. 63/228,182, filed on Aug. 2, 2021.

(51) Int. Cl. G06Q 30/0601; G06Q 10/04; G06Q 30/0283

(52) U.S. Cl. CPC G06Q 30/0627; G06Q 10/04; G06Q 30/0283

(57) ABSTRACT

A method for identifying and providing paint and applicator combinations based on paint application properties includes presenting one or more paint application properties and prompting a user, at the user interface, to provide user input indicating at least one emphasis for at least one of the paint application properties. The method also comprises identifying an optimization function that is based on the at least one emphasis and a data structure that includes quantitative measurements of the at least one of the paint application properties for a plurality of paint and applicator combinations. The method also comprises identifying and presenting an optimal paint and applicator combination from the plurality of paint and applicator combinations that maximizes the optimization function.

### BACKGROUND OF THE INVENTION

### 1. Technical Field

The present invention relates to devices, computer-implemented methods, and systems for identifying a paint and applicator combination.

### 2. Background and Relevant Art

Different architectural paints exhibit different paint application properties (e.g., appearance, visual smoothness, feeling smoothness, hiding, contrast ratio, etc.) when applied to painting surfaces. The paint application properties exhibited by architectural paints can also depend on the applicator used to apply the paint and/or the surface to which the paint is applied. For instance, a particular paint can exhibit one degree of visual smoothness when applied by one paint roller, while the same paint can exhibit a different degree of visual smoothness when applied by a different paint roller.

Different users (e.g., consumers, commercial painters) often have different preferences regarding paint application properties. For instance, one user may highly value visual smoothness while being agnostic toward hiding, whereas another user may place great importance on hiding while being agnostic toward visual smoothness.

Many consumers lack an understanding of paint application properties. Furthermore, many consumers lack an understanding of the paint application properties that a particular combination of an architectural paint, applicator, and/or painting surface will yield.

### BRIEF SUMMARY OF THE INVENTION

The present invention relates to systems, computer-implemented methods, and computer program products directed to identifying and providing paint and applicator combinations. For example, the present invention can comprise a system for identifying and providing paint and applicator combinations based on paint application properties. The present invention can also comprise a computer-implemented method for identifying and providing paint and applicator combinations based on paint application properties. In addition, the present invention can comprise one or more hardware storage devices that comprise computer-executable instructions for identifying and providing paint and applicator combinations based on paint application properties.

For example, a system for identifying and providing paint and applicator combinations based on paint application properties can include one or more processors and one or more hardware storage devices. The one or more hardware storage devices can include computer-executable instructions stored thereon that are operable, when executed by the one or more processors, to cause the system to perform various acts.

The computer-executable instructions can cause the system to present, at a user interface, one or more paint application properties and prompt a user, at the user interface, to provide user input indicating user preferences for at least one of the paint application properties. The user preferences can correspond with at least one emphasis for the at least one of the paint application properties.

The computer-executable instructions can also cause the system to identify an optimization function that is based on the at least one emphasis for the at least one of the paint application properties and a data structure. The data structure can include quantitative measurements of the at least one of the paint application properties for a plurality of paint and applicator combinations. The quantitative measurements can be correlated with qualitative perceptions associated with the at least one of the paint application properties.

The computer-executable instructions can also cause the system to identify an optimal paint and applicator combination from the plurality of paint and applicator combinations that maximizes the optimization function. The computer-executable instructions can further cause the system to present the optimal paint and applicator combination at the user interface.

In another example, a computer-implemented method for identifying and providing paint and applicator combinations based on paint application properties can comprise presenting, at a user interface, one or more paint application properties and prompting a user, at the user interface, to provide user input indicating user preferences for at least one of the paint application properties. The user preferences can correspond with at least one emphasis for the at least one of the paint application properties.

The method can also comprise identifying an optimization function that is based on the at least one emphasis for the at least one of the paint application properties and a data structure. The data structure can include quantitative measurements of the at least one of the paint application properties for a plurality of paint and applicator combinations. The quantitative measurements can be correlated with qualitative perceptions associated with the at least one of the paint application properties.

The method can also comprise identifying an optimal paint and applicator combination from the plurality of paint and applicator combinations that maximizes the optimization function. The method can further comprise presenting the optimal paint and applicator combination at the user interface.

In yet another example, one or more hardware storage devices can comprise computer-executable instructions stored thereon that are operable, when executed by one or more processors of a computing system, to cause the computing system to perform various acts. The computer-executable instructions can cause the computing system to present, at a user interface, one or more paint application properties and prompt a user, at the user interface, to provide user input indicating user preferences for at least one of the paint application properties. The user preferences can correspond with at least one emphasis for the at least one of the paint application properties.

The computer-executable instructions can also cause the computing system to identify an optimization function that is based on the at least one emphasis for the at least one of the paint application properties and a data structure. The data structure can include quantitative measurements of the at least one of the paint application properties for a plurality of paint and applicator combinations. The quantitative measurements can be correlated with qualitative perceptions associated with the at least one of the paint application properties.

The computer-executable instructions can also cause the computing system to identify an optimal paint and applicator combination from the plurality of paint and applicator combinations that maximizes the optimization function. The computer-executable instructions can further cause the system to present the optimal paint and applicator combination at the user interface.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore considered to be limiting of its scope, the invention will be described and explained with additional specificity and detail through the use of the accompanying drawings in which:

FIG. 1 depicts a schematic diagram of a system for identifying and providing paint and applicator combinations based on paint application properties;

FIG. 2 depicts various examples of prompts through which a user can provide user input to a system for identifying and providing paint and applicator combinations based on paint application properties;

FIG. 3 depicts a conceptual representation of a data structure that includes quantitative measurements of paint application properties exhibited by applicator, paint, and surface combinations;

FIG. 4 depicts a conceptual representation of correlations between qualitative perceptions and the quantitative measurements of the data structure depicted in FIG. 3;

FIG. 5 depicts a conceptual representation of identifying an optimization function based at least on user-defined emphases and the data structure depicted in FIG. 3;

FIG. 6 depicts various example formats for a system to provide paint and applicator combinations based on paint application properties; and

FIG. 7 depicts a flow chart that illustrates method acts an example method for identifying and providing paint applicator combinations based on paint application properties.

### DETAILED DESCRIPTION

The present invention relates to systems, computer-implemented methods, and computer program products directed to identifying and providing paint and applicator combinations. For example, the present invention can comprise a system for identifying and providing paint and applicator combinations based on paint application properties. The present invention can also comprise a computer-implemented method for identifying and providing paint and applicator combinations based on paint application properties. In addition, the present invention can comprise one or more hardware storage devices that comprise computer-executable instructions for identifying and providing paint and applicator combinations based on paint application properties.

Users often select architectural paints based on the properties of the paints, such as washability, mildew/moisture resistance, case of application, etc. Similarly, users typically select paint applicators (e.g., paint brushes and paint rollers) based on the properties of the applicators, such as applicator size (e.g., nap size for paint rollers), applicator material (e.g., bristle material for brushes, cover material for rollers), etc.

Accordingly, conventional approaches to selecting an architectural paint and an applicator may fail to account for the fact that an architectural paint can exhibit different paint application properties (e.g., appearance, visual smoothness, feeling smoothness, hiding, contrast ratio, etc.) depending on the applicator used in combination with the architectural paint. The painting surface can also affect the paint application properties exhibited by a particular paint and applicator combination.

The present invention extends to systems, methods, and devices for providing paint and applicator combinations based on paint application properties. For example, a system can include one or more user interfaces configured to receive user input indicating at least one emphasis for at least one paint application property, one or more processors, and one or more hardware storage devices that store instructions that are executable by the one or more processors to configure the system to identify and present an optimal paint and applicator combination based on the at least one emphasis for the at least one paint application property.

In some embodiments, a system can present one or more paint application properties, prompt a user to provide user input indicating user preference(s) related to the paint application property/properties, and identify an optimization function.

The optimization function can be based on at least one emphasis that corresponds to the user preference(s) and a data structure including quantitative measurements associated with the paint application property/properties. The quantitative measurements can be correlated with qualitative perceptions associated with the paint application property/properties. The system can also identify an optimal paint and applicator combination that maximizes the optimization function, and present the optimal paint and applicator combination at a user interface.

Those skilled in the art will recognize, in view of the present disclosure, that the present invention contrasts greatly with routine, conventional, and well-understood approaches to providing architectural paints and applicators for user selection. Conventional approaches to providing architectural paints and applicators for user selection are often driven by providing architectural paints for selection based on the attributes of the architectural paints (e.g., washability, mildew/moisture resistance), and by providing applicators for selection based on the attributes of the applicators (e.g., applicator size or material).

Instead, the present invention relates to a system for selecting an optimal paint and applicator combination that is driven by user-selected preferences related to paint application properties and quantitative measurements of the paint application properties exhibited by different combinations of paints and applicators. Advantageously, the present invention can account for the interdependence of paint selection and applicator selection by providing an optimal paint and applicator combination, rather than a recommendation for a paint only or for an applicator only. In some instances, implementations of the present invention can give users (e.g., inexperienced users) increased confidence in selecting architectural paints and applicators.

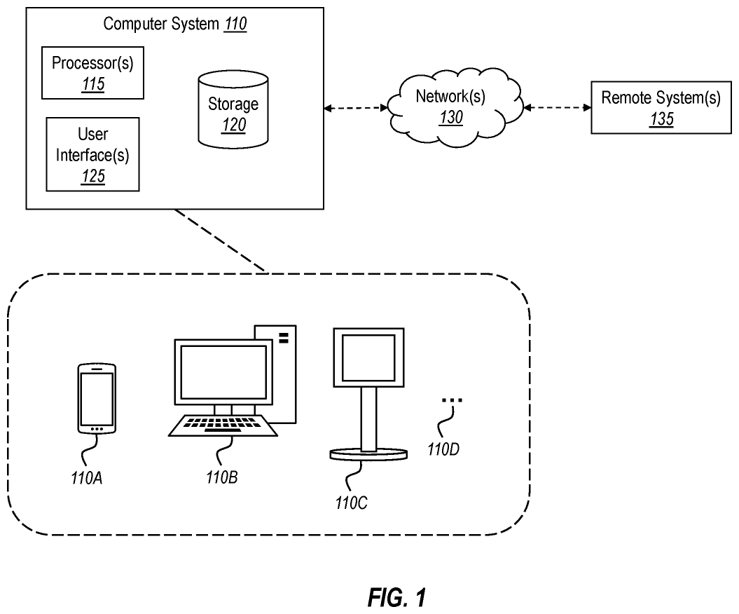

FIG. 1 depicts a schematic diagram of a system (e.g., computer system 110) for identifying and providing paint and paint applicator (or “applicator”) combinations based on properties of the paint as applied (or “paint application properties”). By way of explanation, “applicators” or “paint applicators” as illustrated or described herein generally refer to contact-based applicators, such as paint brushes or paint rollers. However, this is primarily for purposes of convenience in description, and one will appreciate that principles of the present invention for combining application metrics of a coating and applicator can also be applied to spray applicators, such as paint atomizers or paint sprayers. Referring again to FIG. 1, the computer system 110 can include various components, such as processor(s) 115, storage 120, and/or user interface(s) 125. Storage 120 can store computer-executable instructions that are executable by the processor(s) 115 to perform certain acts, such as those described herein for identifying and providing a paint and applicator combination based on paint application properties.

FIG. 1 illustrates that the computer system 110 may take on various forms. For example, the computer system 110 may be embodied as a mobile device 110A, a desktop 110B, a kiosk 110C, or any other computing device(s) (as indicated by ellipsis 110D). The computer system 110 may also be a distributed system that includes one or more connected computing components/devices that are in communication with computer system 110.

For example, FIG. 1 illustrates that the computer system 110 may be connected (via a wired or wireless connection) to remote system(s) 135 via a network 130. In some instances, the network 130 may itself be a cloud network. The computer system 110 may, in some instances, communicate with any number of devices (e.g., remote storage, remote computing systems) or cloud services to obtain data, process data, and/or carry out any computer functionalities or processing described herein (e.g., functionalities of computer system 110 or components thereof). By way of non-limiting example, the computer system 110 can provide the user interface(s) 125 through which a user can interact with the computer system 110, and the computer system 110 can communicate with a remote server (e.g., remote system(s) 135) that carries out at least some of the processing for determining an optimal paint and applicator combination.

A user can interact with the computer system 110 (e.g., via user interface(s) 125) to provide user inputs and to receive a recommendation for a paint and paint applicator combination. The user interface(s) 125 can include any type of input and/or output device. Such devices can include, but are not limited to, touch screens, displays, a mouse, a keyboard, a controller, sensors (e.g., gesture sensors) and so forth. Any type of input or output device could be included among the user interface(s) 125, without limitation.

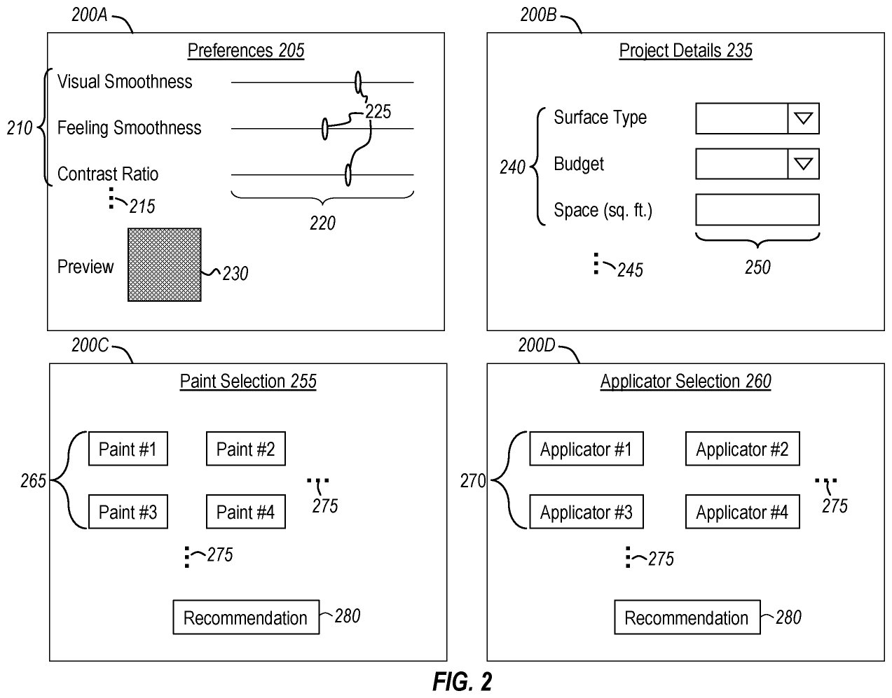

FIG. 2 depicts various examples of prompts (e.g., preferences prompt 200A, project details prompt 200B, paint selection prompt 200C, and applicator selection prompt 200D) through which a user can provide user input to a system (e.g., computer system 110) for identifying and providing paint and applicator combinations based on paint application properties. The example prompts of FIG. 2 (or variations thereof) can be implemented using user interface(s) 125 of a computer system 110.

Preferences prompt 200A illustrates a prompt for obtaining user preferences 205. A user can provide user input indicating preferences 205 associated with paint application properties 210. The preferences prompt 200A displays various paint application properties 210, including visual smoothness, feeling smoothness, and contrast ratio. The ellipsis 215 indicate that, in some instances, a preferences prompt 200A can include more or fewer than the paint application properties illustrated in preferences prompt 200A. For example, a preferences prompt 200A can include at least one of visual smoothness, feeling smoothness, contrast ratio, spatter, hiding, shed, coverage, and/or price.

As used herein, “visual smoothness” and “feeling smoothness” (sometimes referred to as appearance) relate to the how smooth or rough an architectural paint appears or feels, respectively, when applied to a surface. “Contrast ratio” refers to the ratio of the reflectance that a paint exhibits when applied on a black surface to the reflectance that the same paint exhibits when applied on a white surface. “Spatter” refers to the amount of paint that flies off of an applicator when the paint is being applied to a surface by the applicator.

Furthermore, as used herein, “hiding” refers to the ability of an architectural paint to obscure/hide the surface upon which it is applied. Shed relates to the amount of applicator material (e.g., roller filament) that becomes disposed on the application surface from the applicator when applying paint to the surface with the applicator. “Coverage” refers to the amount of surface area that a paint can cover when applied by an applicator to the particular surface (or, for instance, a surface area covered per unit of paint). “Transfer efficiency” refers to the percentage by weight of paint transferred to the substrate out of the paint that was loaded on the applicator, when a specific surface area is painted. “Ease of application” (sometimes referred to as brush drag when the applicator is a brush or stickiness when the applicator is a roller) refers to the force needed to apply paint with an applicator.

Paint application properties, as exhibited by a particular combination of paint, applicator, and application surface, cannot typically be predicted by exclusively considering, the paint, the applicator, or the application surface alone. Rather, the paint application properties that are exhibited when an architectural paint is applied to a surface often depend on the particular combination of paint, applicator, and application surface utilized together.

The user can provide their preferences 205 within the preferences prompt 200A in the form of an emphasis for any number of the displayed paint application properties. For example, FIG. 2 illustrates emphasis indicators 220 displayed within preferences prompt 200A in association with corresponding paint application properties 210. A user can indicate emphases 225 with, for example, movable markers associated with the emphasis indicators 220, which in this case is illustrated as a slide range along which the user can slide a given emphasis 225. Thus, the position of the emphases 225 as directed by the user can indicate the level of importance that a user places on the various paint application properties 210.

For example, one end of the emphasis indicators 220 (e.g., the left end) can represent a low level of importance, whereas an opposing end of the emphasis indicators 220 (e.g., the right end) can represent a high level of importance. In such an example, a particular user can operate a user interface 125 to provide user input to change the position of the movable marker(s) of the emphasis indicators 220 to indicate the level of importance or emphasis 225 that the user places on the corresponding paint application property/properties 210. A system can utilize the user-defined emphases 225 (or “emphasis marker(s)) to determine an optimal paint and applicator combination that is tailored to a particular user's preferences 205 (or emphases 225), as explained hereinafter.

Those skilled in the art will appreciate, in view of the present disclosure, that the particular format of receiving user input to identify user emphases 225 (e.g., with movable markers of the emphasis indicators 220) depicted in preferences prompt 200A is illustrative only and non-limiting. For example, other formats for receiving user input, such as text/numerical input, object selection, and/or any other suitable format are within the scope of this disclosure.

In some instances, users can be inexperienced in field of architectural paints and applicators. Thus, in some implementations, a system can present a preferences prompt 200A with default emphasis values in place that a user can subsequently modify. The default values can be based on observed preferences of other users and/or other user input that has been provided by the particular user. Furthermore, in some implementations, a system can provide, within the preferences prompt 200A, descriptions or other examples related to the paint application properties 210 to increase the user's understanding of the various paint application properties 210.

Additionally, or alternatively, a system can present a dynamically updatable preview 230 of a paint application sample. The dynamically updatable preview 230 can be updated based on the user-defined emphases (e.g., the positions of the movable emphasis markers 225 on the emphasis indicators/slide area 220). Thus, in some instances, the dynamically updatable preview 230 can visually illustrate to users how changes to the paint application properties 210 influence the attributes of a paint as applied to a surface. In this regard, the emphasis values that are selectable within the preferences prompt 200A can be correlated with visual representations of the various paint application properties 210 that can be combined to generate the dynamically updatable preview.

The project details prompt 200B of FIG. 2 shows a prompt for obtaining project details 235. A user can provide user input indicating project details 235 for a particular paint application project for which the user is selecting a paint and applicator combination. The project details prompt 200B displays various details 240, such as surface type, budget, and space (sq. ft.) that describe the user's paint application project. The ellipsis 245 indicates that a project details prompt 200B can include any number of details 240 related to the user's paint application project (or other details). Project details 235, such as surface type, can constrain the paint and applicator combination provided by the computer system 110, as described hereinbelow.

Project details prompt 200B depicts the various details 240 in association with various user input fields 250. Project details prompt 200B illustrates that the various user input fields 250 can comprise different types of formats (e.g., selection menus and/or text fields). One will recognize, in view of the present disclosure, that other user input formats are within the scope of this disclosure.

In some instances, a user can have reason to constrain the paint and applicator combination provided by the system. By way of non-limiting example, a user can already have possession of a particular paint, and the user may desire to receive an applicator recommendation that will yield desirable paint application results in view of the user's paint application preferences 205 (e.g., provided in preferences prompt 200A). In another example, a user can already have possession of a particular applicator, and the user may desire to receive a paint recommendation that will yield desirable paint application results in view of the user's paint application preferences 205 (e.g., provided in preferences prompt 200A).

In yet another example, a user can already have possession of a particular paint and a particular applicator, and the user may desire to learn whether their already-possessed paint and applicator will yield desirable paint application results in view of the user's paint application preferences 205 (e.g., provided in preferences prompt 200A). One will appreciate, in view of the present disclosure, that numerous reasons exist as to why a user might desire to constrain a paint and applicator combination provided by the computer system 110.

Accordingly, paint selection prompt 200C and applicator selection prompt 200D illustrate prompts for obtaining a paint selection 255 and an applicator selection 260, respectively. A user can identify a paint selection 255 from various selectable paints 265 and/or an applicator selection 260 from various selectable applicators 270, within the paint selection prompt 200C and/or the applicator selection prompt 200D, respectively. Ellipses 275 indicate that the paint selection prompt 200C and the applicator selection prompt 200D can include any number of selectable paints 265 and/or selectable applicators 270, respectively. In some instances, the user's paint and/or applicator selection (if provided by the user) can influence or constrain the ultimate paint and applicator combination that the system provides in response to the user input.

Paint selection prompt 200C and applicator selection prompt 200D also illustrate recommendation buttons 280. In some instances, in response to a user selection of a recommendation button 280, a computer system 110 can provide a recommendation for a paint and/or applicator to constrain the paint and applicator combination provided by the system 110. The recommendation can be based on user data for a user providing user input to the computer system 110 and/or based on other user data (e.g., based on purchasing/selection trends of other users, based on available store inventory, etc.). By way of non-limiting example, a computer system 110 can identify a specified budget provided by a user that was previously provided as user input (e.g., pursuant to project details prompt 235 as a project detail 240) and identify a paint selection 255 and/or applicator selection 260 (or subset of paints and/or applicators) that fits within the budget. The computer system 110 can then constrain the paint and applicator combination provided by the computer system by the identified paint selection 255 and/or applicator selection 260 (or subset of paints and/or applicators).

In some instances, however, a user might desire not to constrain the paint and applicator combination provided by the computer system 110. For example, a user may desire to receive the paint and applicator combination that will most closely align with the user's defined preferences 205 for paint application properties 210, regardless of any potential constraints (e.g., budgetary constraints). Accordingly, in some instances, a user can refrain from providing user input for identifying (or triggering identification of) a paint selection 255 and/or an applicator selection 260. For instance, the system may provide one or more selectable “none specified” (or equivalent) buttons that the user may select rather than providing a paint selection 255 and/or an applicator selection 260.

Furthermore, those skilled in the art will appreciate, in view of the present disclosure, that the particular organization, arrangement, configuration, and/or inclusion of the various components of the various prompts shown and described with reference to FIG. 2 can be modified in various implementations of the present disclosure. For instance, the various components of the prompts of FIG. 2 can be organized into a single prompt or any number of prompts, and at least some of the components shown in FIG. 2 can be omitted in some implementations.

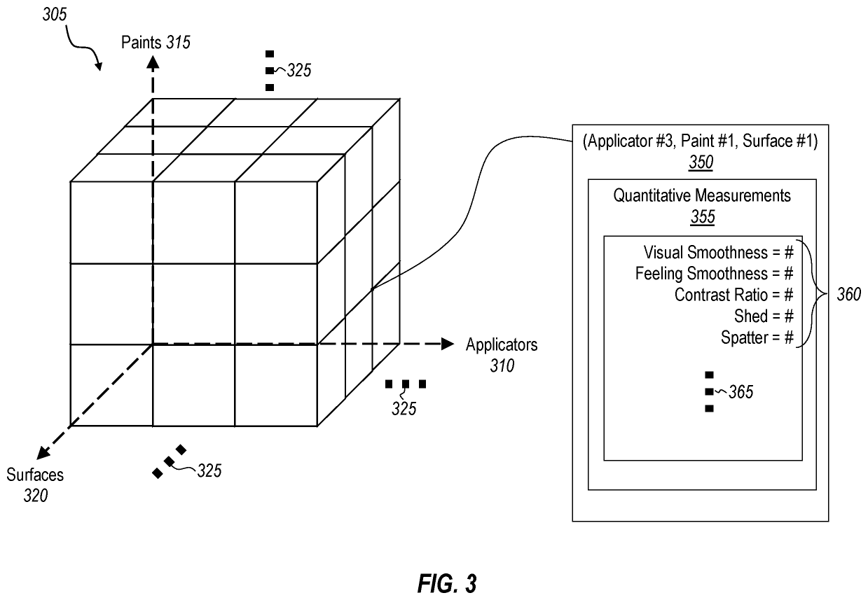

FIG. 3 depicts a conceptual representation of a data structure 305 that includes quantitative measurements 355 of paint application properties 360 exhibited by various combinations of applicators 310 (corresponding to applicators 270, FIG. 2), paints 315 (corresponding to paints 265, FIG. 2), and surfaces 320. FIG. 3 conceptually represents the data structure 305 as a graph with three dimensions, axes, or variables. One axis represents an index of various applicators 310, another axis represents an index of various paints 315, and another axis represents an index of various surfaces 320. The ellipses 325 indicate that the indices for the various applicators 310, paints 315, and surfaces 320 can include any number of entries. For instance, an index of various surfaces 320 might only include one surface (e.g., drywall) or more than one surface.

The various data structures corresponding to applicators 310, paints 315, and surfaces 320 can form various combinations with one another (e.g., combinations of one paint, one applicator, and one surface). The combinations of the various applicators 310, paints 315, and surfaces 320 can be represented as ordered triples. For example, the ordered triple 350 can represent the combination of the third applicator in the index of various applicators 310 (Applicator #3), the first paint in the index of various paints 315 (Paint #1), and the first surface in the index of various surfaces 320 (Surface #1).

FIG. 3 illustrates that the data structure 305 can associate quantitative measurements of paint application properties with the various combinations of applicators 310, paints 315, and surfaces 320. For example, ordered triple 350 can be associated with quantitative measurements 355 of the paint application properties 360 that can be exhibited by particular combination represented in ordered triple 350. FIG. 3 shows that the quantitative measurements 355 are for the paint application properties 360 of visual smoothness, feeling smoothness, contrast ratio, shed, and spatter. Ellipsis 365 indicate that any paint, applicator, and surface combination represented in the data structure 305 can have any number of quantitative measurements 355 for paint application properties 360 associated therewith.

The quantitative measurements (e.g., quantitative measurements 355) can include numerical representations of the various paint application properties (e.g., paint application properties 360) exhibited by the various combinations of applicators 310, paints 315, and surfaces 320. For instance, numerical representations of visual and feeling smoothness can be obtained by measuring and analyzing the wavelengths of the surface textures of a particular paint that has been applied to a particular surface with a particular applicator to obtain a surface smoothness/roughness rating (e.g., based on micrometer values representing profile roughness parameters and/or area roughness parameters). Furthermore, numerical representations of contrast ratio and/or hiding can be obtained via spectrometry, or spectrophotometry. In some implementations, hiding can be indicated as a multiple of contrast ratio.

Numerical representations of coverage can be obtained by measuring the covered surface area of a particular surface after a particular paint is uniformly applied to the surface with a particular applicator. Also, numerical representations of spatter can be obtained by assessing the coverage or weight of the paint that flies off of a particular applicator when applied to a particular surface. In some instances, the spatter can be indicated as a percentage of the coverage or weight. Furthermore, numerical representations of shed can be obtained by quantifying the applicator material (e.g., number of filament/fibers) of a particular applicator that becomes disposed on a particular surface when applying a particular paint (e.g., per unit area). In some instances, shed can be represented as a percentage of the total applicator material or as a weight.

In one illustrative, non-limiting example, an ordered triple representing the combination of a woven polyester roller with nap size (hair length) ⅜″ (applicator) with an interior latex paint on drywall (surface) can be associated with the following approximate quantitative measurements 355 for paint application properties 360: visual smoothness rating=0.33 (within a range of [−0.08, 0.74]), feeling smoothness rating=1.74 (within a range of [1.33, 2.16]), contrast ratio=96.14 (within a range of [95.63, 96.64]), shed count=17.39 (within a range of [14.51, 20.27]), and spatter=0.11 (within a range of [−0.12, 0.34]).

The quantitative measurements 355 can comprise various formats, such as a single numerical value, a plurality of numerical values, a measure of center of a plurality of numerical values (e.g., a median, mean, mode), a range of values, etc. In some instances, the quantitative measurements 355 represent predicted values (based on a plurality of observed measurements) for the paint application properties 360 if the particular combination of applicator, paint, and surface described by the quantitative measurements 355 is used.

In this regard, the each ordered triple (e.g., ordered triple 350) represented within the data structure 305 can be associated with quantitative measurements 355 of paint application properties 360 that were observed for each applicator, paint, and surface combination described by each ordered triple. One will appreciate, in view of the present disclosure, that the information/data described herein as part of the data structure 305 can be stored and/or organized in any suitable form, whether it be in a single data file/page or distributed across a plurality of data objects or repositories. Additionally, the data structure can be updated to add, remove, and/or modify information associated therewith (e.g., ordered triples 350 and/or quantitative measurements 355 associated therewith).

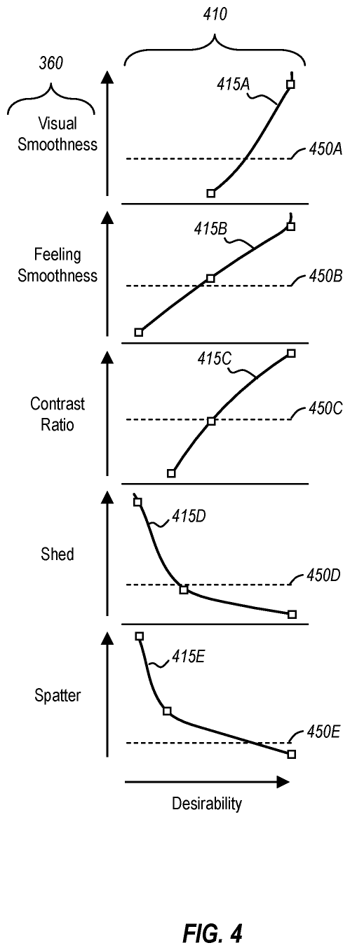

FIG. 4 depicts a conceptual example of correlations between qualitative perceptions and the quantitative measurements 355 of paint application properties 360 associated with the ordered triples depicted and discussed with reference to FIG. 3. FIG. 4 depicts the various paint application properties 360 in association with corresponding desirability graphs 410. The desirability graphs 410 can correlate the quantitative measurements 355 for the paint application properties 360 with qualitative/human perceptions related to the various paint application properties 360.

For example, each desirability graph 410 can include an axis for quantitative measurements 355 for the corresponding paint application property 360 (e.g., the various vertical axes of FIG. 4). For instance, each vertical axis can represent a range of quantitative measurements 355 for each corresponding paint application property 360, beginning at each origin with low values and increasing to higher values vertically along each axis. Each desirability graph 410 can also include an axis for qualitative/human perceptions (e.g., the horizontal desirability axis of FIG. 4). For instance, the desirability axis can represent a range of qualitative/human perceptions, beginning at the origin with low values (e.g., representing qualitative/human perceptions associated with a low level of desirability) and increasing to higher values horizontally along the axis.

Accordingly, each desirability graph 410 can depict the relationship between qualitative/human perceptions and the quantitative measurements 355 for the various paint application properties 360. For example, each desirability graph 410 can include a desirability curve (e.g., desirability curves 415A-415E) that illustrates different qualitative/human perceptions (e.g., represented as desirability values) for different quantitative measurements 355. For example, in some instances where smoothness is considered desirable, the desirability curve 415A for visual smoothness indicates that desirability can increase for higher quantitative measurements 355 representing visual smoothness (e.g., where higher quantitative measurements 355 representing visual smoothness indicate a higher degree of smoothness). FIG. 4 also illustrates the desirability curves 415B and 415C for feeling smoothness and contrast ratio, respectively, with a similar positive relationship between quantitative measurements 355 and desirability.

In contrast, FIG. 4 depicts desirability curves 415D and 415E as decreasing for higher quantitative measurements 355 representing shed and spatter. Thus, the desirability curves 415D and 415E of FIG. 4 can indicate that, in at least some instances, a high degree of shed and/or spatter can be considered undesirable.

The qualitative/human perceptions represented in the desirability curves 415A-415E can be obtained in a variety of ways. For example, one or more human subjects can be presented with a painted surface that was painted with a particular applicator, and the one or more human subjects can provide qualitative input/feedback (e.g., in numerical form or not) indicating a level or degree of desirability for various paint application properties 360 exhibited by the particular combination of paint, applicator, and surface. This process can be repeated for numerous combinations of paints, applicators, and surfaces that include different quantitative measurements 355 for the paint application properties exhibited thereby.

The qualitative input/feedback obtained from the one or more human subjects can be associated with numerical values (if not already in the form of suitable numerical values) for generating desirability curves (e.g., desirability curves 415A-415E). The numerical values associated with the qualitative input/feedback can take on any appropriate scale and/or format (e.g., a numerical scale from zero to one or any other number, with any desired degree of precision or scale). Furthermore, one will appreciate that the desirability curves 415A-415E can have a constant and/or varying slope.

Those skilled in the art will recognize, in view of the present disclosure, that the numerical values representing qualitative/human perceptions can be at least partially discretized. For example, in at least some instances, desirability curves 415A-415E can be generated at least partially employing interpolation, extrapolation, and/or curve-fitting methods. Accordingly, in some instances, numerical values representing qualitative/human perceptions can be omitted for at least some quantitative measurements 355 for paint application properties 360.

One will also note, in view of the present disclosure, that the qualitative/human perceptions provided by human subjects will vary from human to human. In some instances, the numerical values associated with the qualitative input/feedback provided by the human subjects can comprise a measure of center, measure of deviation, and/or any other numerical representation derived from the qualitative/human perceptions.

Those skilled in the art will recognize, in view of the present disclosure, that the desirability curves 415A-415E of the desirability graphs 410 and the relationships represented thereby are illustrative only and non-limiting. For instance, different groups of humans can have different preferences regarding paint application properties. For example, a group of humans in one geographic region can consider a high degree of smoothness desirable (as reflected by desirability curves 415A and 415B in FIG. 4), whereas another group of human (perhaps in a different geographic region) can consider a high degree of roughness desirable.

Thus, in some implementations of the present disclosure, a computer system 110 can employ different desirability curves for identifying an optimal paint and applicator combination for different users (e.g., one desirability curve for users who find smoothness desirable, another desirability curve for users who find roughness desirable, etc.). In some instances, a computer system 110 can obtain user input (e.g., geographic location, categorical preferences such as whether smoothness is preferred or roughness, etc.) to determine which desirability curves to use to identify a paint and applicator combination for a particular user.

By way of illustrative example, FIG. 4 depicts, on the various desirability graphs 410 as a horizontal dashed lines 450A-450E, the particular quantitative measurements 355 for the paint application properties 360 exhibited by the ordered triple 350 (shown and described with reference to FIG. 3). The intersections between the each of the various desirability curves 415A-415E and the various horizontal dashed lines 450A-450E can represent how desirable the particular combination of applicator, paint, and surface represented in ordered triple 350 will be with respect to each paint application property 360 (considered separately).

In one instance, where desirability is represented within a range of zero to one (with zero indicating undesirable and one indicating most desirable), where smoothness is considered desirable rather than roughness, and where the ordered triple 350 represents the combination of a woven polyester roller with nap size (hair length) ⅜′ (applicator) with an interior latex paint on drywall (surface), the ordered triple 350 can exhibit a desirability of approximately 0.76 for visual smoothness (where horizontal dashed line 450A intersects with desirability curve 415A), approximately 0.50 for feeling smoothness (where horizontal dashed line 450B intersects with desirability curve 415B), approximately 0.56 for contrast ratio (where horizontal dashed line 450C intersects with desirability curve 415C), approximately 0.37 for shed (where horizontal dashed line 450D intersects with desirability curve 415D), and approximately 0.84 for spatter (where horizontal dashed line 450E intersects with desirability curve 415E).

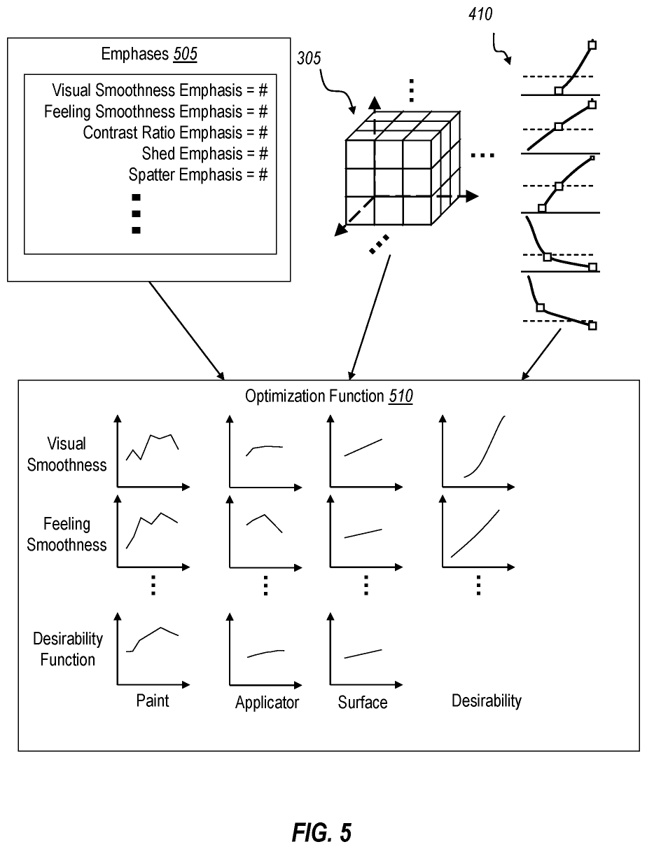

FIG. 5 depicts a conceptual representation of identifying an optimization function 510 based at least on user-defined emphases 505 and the data structure 305 depicted in FIG. 3 (as indicated by the arrows extending from the emphases 505, the data structure 305, and the desirability graphs 410 toward the optimization function 510. FIG. 5 also depicts the optimization function 510 being identified based on the qualitative/human perceptions represented in the desirability graphs 410 depicted in FIG. 4. A computer system 110 can identify an optimization function 510 by generating an optimization function based on accessible data (e.g., the data structure 305, the emphases 505, and/or the desirability information of the desirability graphs 410) and/or by accessing an existing optimization function 510 stored in a local and/or remote repository (e.g., storage 120, remote system(s) 135).

The user-defined emphasis 505 can be based at least in part on the user input indicating user preferences 205 provided pursuant to the preferences prompt 200A (e.g., indicating emphases 225 in FIG. 2). The user-defined emphases 505 can be conceptualized as numerical weights or importance indicators (e.g., taking on values between zero and one) that the computer system 110 can employ when analyzing the information from the data structure 305 and from the desirability graphs 410 in determining an optimal paint and applicator combination.

The optimization function 510 can be implemented as any suitable multiple response optimization approach, model, or method, such as, for example, a desirability function-based approach, a Mahalanobis distance-based approach, multiple regression and/or linear programming-based approaches, and/or utility function-based approaches.

In some instances, the optimization function 510 can be implemented as a desirability function. In such instances, the computer system 110 can identify the optimization function 510 by generating a desirability function using at least a portion of the quantitative measurements 355 of the data structure 305 (for each paint application property 360 of each ordered triple 350 of the data structure 305) as input values, the numerical values representing qualitative/human perceptions that underlie the desirability graphs 410 to define desirability, and the emphases 505 as weights or importance indicators. In some instances, the computer system 110 can employ one or more statistical software packages to generate the optimization function 510 (e.g., desirability function), such as, by way of example only, SPSS, JMP, STATA, SAS, R, and/or MATLAB.

After identifying the optimization function 510, a computer system 110 can identify a particular ordered triple 350 that maximizes the desirability function. The particular ordered triple 350 that maximizes the desirability function will have a highest desirability value as compared with that of the other ordered triples, in view of the emphases 505 and any other constraints placed on the identification of the optimal ordered triple 350 (e.g., paint selection, applicator selection, surface type selection, see FIG. 2).

As an illustrative example, a computer system 110 could obtain the following emphases for paint application properties 210 via user input within a preferences prompt 200A (or variation thereof): visual smoothness emphasis=1.0, feeling smoothness emphasis=0.5, contrast ratio emphasis=1.0, shed emphasis=0.75, and spatter emphasis=0.2. The computer system could also identify a selected paint application surface, drywall, which will constrain the ordered triple that the computer system 110 will identify as maximizing the desirability function. In such cases, the optimal ordered triple can be thought of as an optimal paint and applicator combination, as referred to herein.

The computer system 110 can also identify a data structure 305 that includes quantitative measurements 355 for paint application properties 360 exhibited by various applicator, paint, and surface combinations (e.g., ordered triples 350). Continuing with the above-noted example, the ordered triples 350 of an example data structure 305 can include the following paints: PPG GLIDDEN PREMIUM, PPG DIAMOND, and PPG TIMELESS. The ordered triples 350 of the data structure 305 can also include the following applicators: PPG PROSUPREME WOVEN 3/16″. WOOSTER PRO WOVEN ⅜″. WOOSTER PRO/DOO-Z FTP ⅜″, WOOSTER SUPER DOO-Z ⅜″, WOOSTER PRO SURPASS ½″, and WOOSTER SUPER/FAB KNIT ½″. The ordered triples 350 of the data structure 305 can also include the following surfaces: drywall and LENETA, but, as noted above, the selection of the optimal ordered triple will be constrained by the identified selection of “drywall” as the paint application surface.

The computer system 110 can also identify qualitative perceptions correlated with the quantitative measurements 355 for the paint application properties 360 exhibited by various paint, applicator, and surface combinations (whether they be the same as those included in the data structure or at least partially different). The qualitative perceptions can be obtained from human subjects when presented with painted surfaces that were painted according to various ordered triples 350 (such as those represented in the desirability graphs 410 illustrated in FIG. 4).

The computer system can then identify the optimization function 510 by generating (or accessing) a desirability function based on the emphases 505 (as importance/weighting input); the quantitative measurements 355 for the paint application properties 360 exhibited by the above-noted combinations of applicators, paints, and surfaces (as values input); and the qualitative perceptions (as desirability input). In some instances, the computer system 110 omits applicators, paints, and/or surfaces that are precluded from consideration as part of the optimal ordered triple 350 (e.g., by a selection that operates as a constraint), such as the LENETA surface in the current example since drywall was identified as the paint application surface.

Continuing with the above-noted example, the computer system 110 can analyze the desirability function to identify a paint and applicator combination with the highest desirability, accounting for the above-noted emphases 505 and the above-noted “drywall” constraint. The computer system 110 could determine, for instance, that for the PPG GLIDDEN PREMIUM paint, the applicator that provides the highest desirability is the WOOSTER SUPER/FAB KNIT ½″ applicator (when applied to drywall), with a desirability of approximately 0.55. The computer system 110 could also determine, for instance, that for the PPG DIAMOND paint, the applicator that provides the highest desirability is the WOOSTER PRO WOVEN ⅜″ applicator (when applied to drywall), with a desirability of approximately 0.75. The computer system 110 could also determine, for instance, that for the PPG TIMELESS paint, the applicator that provides the highest desirability is the WOOSTER SUPER DOO-Z ⅜″ applicator (when applied to drywall), with a desirability of approximately 0.0.65.

Based on the foregoing analysis, the computer system 110 can identify the paint and applicator combination of the PPG DIAMOND paint and the WOOSTER PRO WOVEN ⅜″ as the optimal paint and applicator combination that maximizes the optimization function 510 in view of the user-defined emphases 505 and in view of the “drywall” constraint.

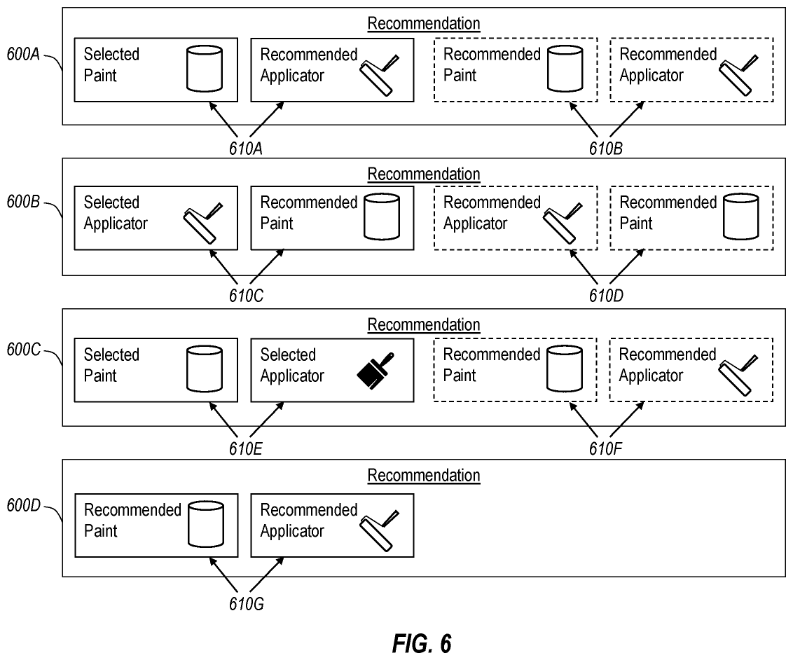

FIG. 6 depicts various example formats (e.g., format, 600A, 600B, 600C, and 600D) for a computer system 110 to provide and/or present paint and applicator combinations 610 (e.g., paint and applicator combinations 610A-610G). In some instances, the computer system 110 can present a paint and applicator combination 610 on user interface(s) 125.

The paint and applicator combinations 610 can be constrained, in some instances, by user selections. For example, format 600A depicts a recommended paint and applicator combination 610A that a computer system 110 can provide when constrained by a selected paint (e.g., an identified paint selection 255). Thus, the recommended paint and applicator combination 610A can include the selected paint and a recommended applicator. Similarly, format 600B depicts a recommended paint and applicator combination 610C that a computer system 110 can provide when constrained by a selected applicator (e.g., an identified applicator selection 260). Thus, the recommended paint and applicator combination 610C can include the selected applicator and a recommended paint. Format 600C illustrates an example in which a recommended paint and applicator combination 610E is constrained by both a selected applicator and a selected paint, such that the recommended paint and applicator combination 610E includes both the selected applicator and the selected paint.

In some instances, the paint and applicator combination 610A that is constrained by the user selection (e.g., an identified paint selection 255, applicator selection 260, or both) does not represent the ordered triple 350 within the data structure 305 that has the highest overall desirability value (in view of the user emphases 505 and the desirability graphs 410). For example, in some instances, a different ordered triple 350 within the data structure 305 that is not constrained by the user selection(s) can have a higher overall desirability value than that of the paint and applicator combination 610A, 610C, 610E that is so constrained. Thus, in some instances, example formats 600A, 600B, and 600C can present additional paint and applicator combinations 610B, 610D, and 610F, respectively, that include a recommended applicator (which can be different than an applicator selection 260) and a recommended paint (which can be different than a paint selection 255) that are not constrained by user selections.

Format 600D illustrates a paint and applicator combination 610G that a computer system 110 can provide when unconstrained by paint or applicator selections. The paint and applicator combination 610G includes both a recommended paint and a recommended applicator that maximizes the optimization function 510.

Accordingly, disclosed systems and methods can provide several significant benefits to the field relating to identifying paint and applicator combinations. For instance, disclosed embodiments can provide an unconventional system and/or method for identifying paint and applicator combinations based on, and tailored to, user-indicated preferences for paint application properties.

Furthermore, in some instances, implementations of the present disclosure can be configured to allow users to easily and/or directly purchase a recommend paint and applicator combination. For example, a user interface may display a direct purchase element, which may comprise any content or interactive element that assists a user in purchasing at least a part of a paint and applicator combination. For instance, by way of non-limiting example, a direct purchase element may be implemented as a selectable “Buy.” “Order.” “Add to Cart,” or “Call Associate” button that, when selected, allows users to initiate a sales transaction that enables the user to purchase one or more components of the recommended paint and applicator combination (e.g., the paint and/or the applicator). In some instances, a direct purchase element provides identifying information related to one or more components of the paint and applicator combination that assists the user in making a purchase. For instance, the direct purchase element may display a location of a paint and/or applicator within a particular store (e.g., by providing an aisle and/or bay number) and/or other identifying information related to a recommended paint and applicator combination (e.g., a stock keeping number). In some instances, a direct purchase element comprises a QR code or other scannable element that, when scanned by the user, directs the user to identifying information associated with the recommended paint and applicator combination. Furthermore, in some instances, a direct purchase element may comprise or be associated with one or more incentives that may motivate a user to make a purchase (e.g., a coupon, or a QR code that provides a user with a usable coupon). Still furthermore, in some instances, implementations of the present disclosure can be configured to collect and/or utilize user data for various purposes. For instance, a system implementing the disclosed principles may draw associations between user information (e.g., user preferences related to paint application properties, project details, paint/applicator constraints, and/or other information such as user demographic information, etc.) and purchasing/selection decisions ultimately made by users. Such associations may be used, by way of example, as training data to train an artificial intelligence (AI) module (e.g., a predictive or classification model) for improving user experiences and/or generating recommended paint and applicator combinations. For example, an AI model may be trained on training data that includes at least (i) user emphases 255 for paint application properties as training input and (ii) selected paint and/or applicator as ground truth output (e.g., the training data may be drawn from other user interactions). The AI model may then be used as an additional or alternative process for generating a recommended paint and applicator combination (e.g., separate recommendations may be generated via an optimization function as discussed above and via an AI model, and the recommendations may optionally be combined to generate a final output recommendation).

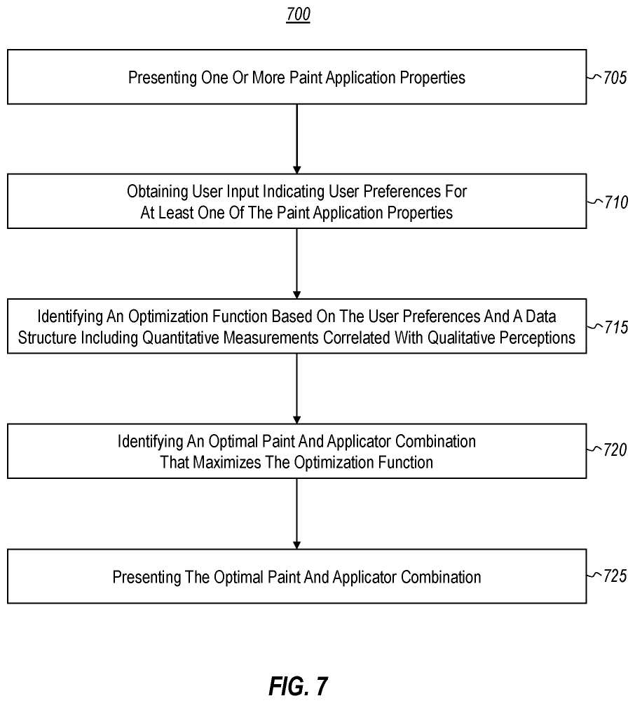

FIG. 7 depicts a flow chart that illustrates acts in an example method 700 for identifying and providing paint applicator combinations based on paint application properties. The various acts of the method 700 can be carried out, in some implementations, utilizing one or more components of a computer system 110 (e.g., processor(s) 115, storage 120, user interface(s) 125) and/or remote systems/components that are in communication therewith. The following description of the method 700 sometimes parenthetically refers to elements of FIGS. 1-6 to provide illustrative examples.

FIG. 7 shows that method 700 can include an act 705 of presenting one or more paint application properties (210, 360). The paint application properties (210, 360) can include, for example, appearance, spatter, hiding, shed, coverage, contrast ratio, visual smoothness, feeling smoothness, and/or price. In some instances, a computer system 110 can present the one or more paint application properties (210, 360) at a user interface 125 with default values for each of the one or more paint application properties (210, 360). The default values can be based, for example, on one or more observed preferences of other users associated with the paint application properties (210, 360).

The computer system 110 can also provide descriptions, examples, and/or previews associated with the paint application properties (210, 360). For example, in some instances, a computer system 110 can present a dynamically updatable preview (230) of a paint application sample that can be updated based on user-indicated preferences (see act 710).

FIG. 7 also shows that method 700 can also include an act 710 of obtaining user input indicating user preferences (205) for at least one of the paint application properties (210, 360). In some instances, a user can provide the user preferences via user interface(s) 125 in any suitable form (e.g., by moving a movable marker, entering a value, selecting a selectable object, etc.). The user preferences can correspond to one or more emphases (225, 505) associated with the paint application properties.

In some instances, a computer system 110 can also obtain other input for identifying an optimal paint and applicator combination, such as a painting surface type (e.g., defined in project details 240), a paint selection (255), an applicator selection (260), etc., by explicit user input and/or via computer-generated recommendation (e.g., via recommendation buttons 280).

In addition, FIG. 7 shows that method 700 can include an act 715 of identifying an optimization function (510) based on the user preferences (225, 505) and a data structure (305) including quantitative measurements (355) correlated with qualitative perceptions (e.g., represented in desirability curves 415A-415E). In some instances, the optimization function (510) is implemented as a desirability function, and the user preferences (255, 505) can operate as weights or importance indicators for the paint application properties (210, 360) within the desirability function. The quantitative measurements (355) of the data structure (305) can be associated with paint application properties (360) exhibited by various ordered triples (350) that represent different combinations of applicators (310), paints (315), and surfaces (320) included within the data structure 305.

Furthermore, FIG. 7 shows that method 700 can include an act 720 of identifying an optimal paint and applicator combination (610) that maximizes the optimization function (510). In some instances, the optimal paint and applicator combination (610) can be constrained by prior-provided user input (e.g., a paint selection 255, an applicator selection 260, a painting surface selection). A computer system can, in some implementations, identify multiple paint and applicator combinations (610), with at least one being constrained by user input and at least one other being not so constrained.

Still further, FIG. 7 shows that method 700 can also include an act 725 of presenting the optimal paint and applicator combination (610). A computer system 110 can present an optimal paint and applicator combination (610) at user interface(s) 125 in various formats (600A-600D).

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, while the invention has been described in terms of “a” data structure, any number of data structures can be used. When ranges are given, any endpoints of those ranges and/or numbers within those ranges can be combined within the scope of the present invention. Including and like terms means “including but not limited to”. Similarly, as used herein, the terms “on”, “applied on/over”, “formed on/over”, “deposited on/over”, “overlay” and “provided on/over” mean formed, overlay, deposited, or provided on but not necessarily in contact with the surface. For example, a paint layer “applied on” a surface does not preclude the presence of one or more other coating layers of the same or different composition located between the formed coating layer and the substrate.

The following describes additional details concerning example computing systems (e.g., computer system 110, remote system(s) 135) that may be used to facilitate the operations described herein.

The disclosed embodiments may comprise or utilize a special-purpose or general-purpose computer including computer hardware, such as, for example, one or more processors (such as processor(s) 115) and system memory (such as storage 120), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Computer-readable media that carry computer-executable instructions are “transmission media.” Thus, by way of example and not limitation, the current embodiments can comprise at least two distinctly different kinds of computer-readable media: computer storage media and transmission media.

The processor(s) 115 may be implemented as one or more general-purpose processing units (e.g., a central processing unit or “CPU”) or as one or more specific processing units (e.g., dedicated processing units) configured to perform one or more specialized operations for the computer system 110. As used herein, the terms “executable module,” “executable component,” “component,” “module,” or “engine” can refer to hardware processing units or to software objects, routines, or methods that may be executed on computer system 110. The different components, modules, engines, and services described herein may be implemented as objects or processors that execute on computer system 110 (e.g. as separate threads). The processor(s) 115 can be configured to perform any of the disclosed method acts or other functionalities.

In some implementations, the processor(s) 115 may comprise or be configurable to execute any combination of software and/or hardware components that are operable to facilitate processing using machine learning models or other artificial intelligence-based structures/architectures. For example, processor(s) 115 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

Furthermore, those skilled in the art will appreciate, in view of the present disclosure, that the functionality of the processor(s) 115 described herein can be performed, at least in part, by one or more hardware logic components. For example, and without limitation, illustrative types of hardware logic components/processors that can be used include Field-Programmable Gate Arrays (“FPGA”), Program-Specific or Application-Specific Integrated Circuits (“ASIC”), Application-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

Storage 120 may be physical system memory, which may be volatile, non-volatile, or some combination of the two. The term “memory” may also be used herein to refer to non-volatile mass storage such as physical storage media. If computer system 110 is distributed, the processing, memory, and/or storage capability may be distributed as well.

Storage 120 can include computer-executable instructions. The computer-executable instructions represent instructions that are executable by the processor(s) 115 of computer system 110 to perform the disclosed operations, such as those described in the various methods. Storage 120 can also include any type of data, such as data related to the types of architectural paints, painting surfaces, or paint applicators; data related to quantitative measurements of paint application properties for various combinations of paints, applicators, and surfaces; correlational data that correlates the quantitative measurements to qualitative perceptions; user-defined emphases or weights (e.g., for multiple users); and so forth, without limitation.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A “network,” like network(s) 130, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 110 will include one or more communication channels that are used to communicate with/through the network 130. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile phones, PDAs, pagers, wearable devices (e.g., head-mounted displays), routers, switches, and the like. The embodiments may also be practiced in distributed system environments where local and remote computer systems that are linked (either by hardwired data links, wireless data links, or by a combination of hardwired and wireless data links) through a network each perform tasks. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this disclosure, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

In view of the foregoing, the present invention may be embodied in multiple different configurations, as outlined above, and as exemplified by the following aspects.

In a first aspect, a system for identifying and providing paint and applicator combinations based on paint application properties can include one or more processors and one or more hardware storage devices storing instructions that are executable by the one or more processors, particularly using a computer-implemented method according to any one of aspects eighteen through nineteen, to configure the system to present, at a user interface, one or more paint application properties; prompt a user, at the user interface, to provide user input indicating at least one emphasis for at least one of the paint application properties; identify an optimization function that is based on: the at least one emphasis for the at least one of the paint application properties, and a data structure including quantitative measurements of the at least one of the paint application properties for a plurality of paint and applicator combinations; identify an optimal paint and applicator combination from the plurality of paint and applicator combinations that maximizes the optimization function; and present the optimal paint and applicator combination at the user interface.

In a second aspect of the system as recited in aspect one, the quantitative measurements of the data structure are correlated with qualitative perceptions associated with the at least one of the paint application properties.

In a third aspect of the system as recited in aspect one or two, the instructions can be executable by the one or more processors to further configure the system to: identify a paint selection, wherein the identification of the optimal paint and applicator combination from the plurality of paint and applicator combinations is constrained by the paint selection.

In a fourth aspect of the system as recited in aspect three, identifying the paint selection can include prompting the user to provide user input indicating the paint selection.

In a fifth aspect of the system as recited in aspect three, identifying the paint selection can include automatically determining the paint selection based on user input.

In a sixth aspect of the system as recited in any one of aspects one through five, the instructions can be executable by the one or more processors to further configure the system to: present an additional optimal paint and applicator combination from the plurality of paint and applicator combinations that is not constrained by the paint selection.

In a seventh aspect of the system as recited in any one of the preceding aspects one through six, the instructions can be executable by the one or more processors to further configure the system to: identify an applicator selection, wherein the identification of the optimal paint and applicator combination from the plurality of paint and applicator combinations is constrained by the applicator selection.

In an eighth aspect of the system as recited in aspect seven, identifying the applicator selection can include prompting the user to provide user input indicating the applicator selection.

In a ninth aspect of the system as recited in aspect seven, identifying the applicator selection includes automatically determining the applicator selection based on user input.

In a tenth aspect of the system as recited in any one of aspects seven through nine, the instructions can be executable by the one or more processors to further configure the system to: present an additional optimal paint and applicator combination from the plurality of paint and applicator combinations that is not constrained by the applicator selection.

In an eleventh aspect of the system as recited in any one of the preceding aspects one through ten, the applicator can be a paint roller or paint brush.

In a twelfth aspect as recited in any one of the preceding aspects one through eleven, the optimization function can be a desirability function.

In a thirteenth aspect of the system as recited in any one of the preceding aspects one through twelve, the instructions can be executable by the one or more processors to further configure the system to: prompt the user to provide user input indicating a painting surface type, wherein: the quantitative measurements of the at least one of the paint application properties for the plurality of paint and applicator combinations depend on painting surface type, and the identification of the optimal paint and applicator combination from the plurality of paint and applicator combinations is constrained by the painting surface type indicated by the user input.

In a fourteenth aspect of the system as recited in any one of the preceding aspects one through thirteen, the at least one of the paint application properties can include at least one of: appearance, spatter, hiding, shed, coverage, contrast ratio, visual smoothness, feeling smoothness, or price.

In a fifteenth aspect of the system as recited in any one of the preceding aspects one through fourteen, the instructions can be executable by the one or more processors to further configure the system to: present a direct purchase element at the user interface, the direct purchase element being usable or selectable by the user to facilitate purchasing of at least part of the optimal paint and applicator combination by the user.

In a sixteenth aspect of the system as recited in any one of the preceding aspects one through fifteen, the system can present the one or more paint application properties at the user interface with default values for each of the one or more paint application properties; and the default values cab be based on one or more observed preferences of other users associated with the at least one of the paint application properties.

In a seventeenth aspect of the system as recited in any one of the preceding aspects one through sixteen, the at least one emphasis for the at least one of the paint application properties can comprise at least one weight for the at least one of the paint application properties.

In an eighteenth aspect, a computer-implemented method for identifying and providing paint and applicator combinations based on paint application properties, particularly used in a system according to any one of aspects one to seventeen, can comprise: presenting, at a user interface, one or more paint application properties; prompting a user, at the user interface, to provide user input indicating at least one emphasis for at least one of the paint application properties; identifying an optimization function that is based on: the at least one emphasis for the at least one of the paint application properties, and a data structure including quantitative measurements of the at least one of the paint application properties for a plurality of paint and applicator combinations; identifying an optimal paint and applicator combination from the plurality of paint and applicator combinations that maximizes the optimization function; and presenting the optimal paint and applicator combination at the user interface.

In a nineteenth aspect of the method as recited in aspect eighteen, the method can further comprise: prompting the user to provide user input indicating a painting surface type, wherein: the quantitative measurements of the at least one of the paint application properties for the plurality of paint and applicator combinations depend on painting surface type, and the identification of the optimal paint and applicator combination from the plurality of paint and applicator combinations is constrained by the painting surface type indicated by the user input.

In a twentieth aspect, a system for identifying and providing paint and applicator combinations based on paint application properties can comprise one or more user interfaces configured to receive user input indicating at least one emphasis for at least one paint application property; one or more processors; and one or more hardware storage devices storing instructions that are executable by the one or more processors to configure the system to identify and present an optimal paint and applicator combination based on the at least one emphasis for the at least one paint application property.

In a twenty-first aspect as recited in any one of the preceding aspects one through twenty, the paint is an architectural paint.

In a twenty-second aspect as recited in any one of the preceding aspects one through twenty-one, the quantitative measurements consider paint application properties of a paint that is applied to a surface, wherein the measured paint application properties depend on the particular combination of paint, applicator, and application surface utilized together.

In a twenty-third aspect as recited in any one of the preceding aspects one through twenty-two, the optimal paint and applicator combination is identified from the plurality of paint, applicator combinations as well as the application surface that maximizes the optimization function.

In a twenty-fourth aspect as recited in any one of the preceding aspects one through twenty-three, a user can provide a user input indicating an application surface for the paint.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A system for identifying and providing paint and applicator combinations based on paint application properties, comprising:
one or more processors; and
one or more hardware storage devices storing instructions that are executable by the one or more processors to configure the system to:
present, at a user interface, one or more paint application properties;
prompt a user, at the user interface, to provide user input indicating at least one emphasis for at least one of the paint application properties;
identify an optimization function that is based on:
the at least one emphasis for the at least one of the paint application properties, and
a data structure including quantitative measurements of the at least one of the paint application properties for a plurality of paint and applicator combinations;
identify an optimal paint and applicator combination from the plurality of paint and applicator combinations that maximizes the optimization function; and
present the optimal paint and applicator combination at the user interface.

2. The system of claim 1, wherein the quantitative measurements of the data structure are correlated with qualitative perceptions associated with the at least one of the paint application properties.

3. The system of claim 1, wherein the instructions are executable by the one or more processors to further configure the system to:
identify a paint selection, wherein the identification of the optimal paint and applicator combination from the plurality of paint and applicator combinations is constrained by the paint selection.

4. The system of claim 3, wherein identifying the paint selection includes prompting the user to provide user input indicating the paint selection.

5. The system of claim 3, wherein identifying the paint selection includes automatically determining the paint selection based on user input.

6. The system of claim 3, wherein the instructions are executable by the one or more processors to further configure the system to:
present an additional optimal paint and applicator combination from the plurality of paint and applicator combinations that is not constrained by the paint selection.

7. The system of claim 1, wherein the instructions are executable by the one or more processors to further configure the system to:
identify an applicator selection, wherein the identification of the optimal paint and applicator combination from the plurality of paint and applicator combinations is constrained by the applicator selection.

8. The system of claim 7, wherein identifying the applicator selection includes prompting the user to provide user input indicating the applicator selection.

9. The system of claim 7, wherein identifying the applicator selection includes automatically determining the applicator selection based on user input.

10. The system of claim 7, wherein the instructions are executable by the one or more processors to further configure the system to:
present an additional optimal paint and applicator combination from the plurality of paint and applicator combinations that is not constrained by the applicator selection.

11. The system of claim 1, wherein the applicator is a paint roller or paint brush.

12. The system of claim 1, wherein the optimization function is a desirability function.

13. The system of claim 1, wherein the instructions are executable by the one or more processors to further configure the system to:
prompt the user to provide user input indicating a painting surface type,
wherein:
the quantitative measurements of the at least one of the paint application properties for the plurality of paint and applicator combinations depend on painting surface type, and
the identification of the optimal paint and applicator combination from the plurality of paint and applicator combinations is constrained by the painting surface type indicated by the user input.

14. The system of claim 1, wherein the at least one of the paint application properties include at least one of: appearance, spatter, hiding, shed, coverage, contrast ratio, visual smoothness, feeling smoothness, transfer efficiency, ease of application, or price.

15. The system of claim 1, wherein the instructions are executable by the one or more processors to further configure the system to:
present a direct purchase element at the user interface, the direct purchase element being usable or selectable by the user to facilitate purchasing of at least part of the optimal paint and applicator combination by the user.

16. The system of claim 1, wherein:
the system presents the one or more paint application properties at the user interface with default values for each of the one or more paint application properties; and
the default values are based on one or more observed preferences of other users associated with the at least one of the paint application properties.

17. The system of claim 1, wherein the at least one emphasis for the at least one of the paint application properties comprises at least one weight for the at least one of the paint application properties.

18. A computer-implemented method for identifying and providing paint and applicator combinations based on paint application properties, comprising:
presenting, at a user interface, one or more paint application properties;
prompting a user, at the user interface, to provide user input indicating at least one emphasis for at least one of the paint application properties;
identifying an optimization function that is based on:
the at least one emphasis for the at least one of the paint application properties, and
a data structure including quantitative measurements of the at least one of the paint application properties for a plurality of paint and applicator combinations;
identifying an optimal paint and applicator combination from the plurality of paint and applicator combinations that maximizes the optimization function; and
presenting the optimal paint and applicator combination at the user interface.

19. The method of claim 18, further comprising:
prompting the user to provide user input indicating a painting surface type, wherein:
the quantitative measurements of the at least one of the paint application properties for the plurality of paint and applicator combinations depend on painting surface type, and
the identification of the optimal paint and applicator combination from the plurality of paint and applicator combinations is constrained by the painting surface type indicated by the user input.

20. A system for identifying and providing paint and applicator combinations based on paint application properties, comprising:
one or more user interfaces configured to receive user input indicating at least one emphasis for at least one paint application property;
one or more processors; and
one or more hardware storage devices storing instructions that are executable by the one or more processors to configure the system to identify and present an optimal paint and applicator combination based on the at least one emphasis for the at least one paint application property.
